(19) United States
(12) Patent Application Publication
(10) Pub. No.: US 2020/0410541 A1
(43) Pub. Date: Dec. 31, 2020

(54) DYNAMICALLY CHANGING DISPLAY ON FOR-HIRE VEHICLES

(71) Applicant: IVSC IP LLC, Las Vegas, NV (US)

(72) Inventor: Mark Alden James, Las Vegas, NV (US)

(21) Appl. No.: 16/847,502

(22) Filed: Apr. 13, 2020

Related U.S. Application Data
(63) Continuation of application No. 16/690,758, filed on Nov. 21, 2019, now abandoned.
Application No. 16/690,758 is a continuation of application No. 16/377,796, filed on Apr. 8, 2019, now abandoned.
Application No. 16/377,796 is a continuation of application No. 15/229,718, filed on Aug. 5, 2016, now abandoned.
Application No. 15/229,718 is a continuation of application No. 13/831,263, filed on Mar. 14, 2013, now abandoned.
(60) Provisional application No. 61/701,572, filed on Sep. 14, 2012.

(51) Int. Cl. G06Q 30/02

(52) U.S. Cl. CPC G06Q 30/0266; G07F 17/0057

(57) ABSTRACT

A dynamic display system on a for-hire vehicle (FHV) is provided, the display system being configured to change displayed information when it is safe and when other conditions are met. The FHV display system can determine it is safe when the FHV is in a defined location or meets other criteria that reduce a probability of violating a law or of other drivers allowing themselves to become distracted by the display change. The FHV display system can be configured to process information about the FHV, including its position and its speed to determine whether safety conditions are met. The FHV display system can include a notification system configured to alert the FHV operator that a display change is requested and to indicate proposed transition locations near the position of the FHV.

### INCORPORATION BY REFERENCE TO ANY PRIORITY APPLICATIONS

Any and all applications for which a foreign or domestic priority claim is identified in the Application Data Sheet as filed with the present application are hereby incorporated by reference in their entireties in accordance with 37 CFR 1.57 and made a part of this specification.

### BACKGROUND

### Field

The present disclosure relates to the field of advertising on for-hire vehicles, and more particularly to the use of dynamic displays on for-hire vehicles.

### Description of Related Art

A for-hire vehicle (FHV) generally charges fares for transporting a passenger from one location to another. FHVs can include taxicabs, limousines, shuttles, buses or any other vehicle that provides shared transportation or transports one or more passengers between locations of the passengers' choice. FHVs are common in tourist destinations, business traveler destinations (for example, where convention centers are prevalent), or in densely populated urban areas where vehicle ownership is uncommon or impractical. Areas of high FHV use provide an opportunity for advertisers, politicians, or other entities to reach a variety of people in a variety of locations by displaying advertisements, messages, or other such information on FHVs.

### SUMMARY

The systems, methods, and devices described herein have innovative aspects, no single one of which is indispensable or solely responsible for their desirable attributes. Without limiting the scope of the claims, some of the advantageous features will now be summarized.

FHVs can include dynamic display technology to display information which is time and/or location sensitive. It can be desirable to use the dynamic display technology to provide a variety of messages to a large number of people by displaying targeted or selected messages while the FHV is in use. These messages may advantageously be configured to be tailored to particular situations, such as times of day and/or location. However, other drivers may allow themselves to become distracted by a dynamic display that changes information or that displays dynamic content (e.g., animated messages) while the FHV to which it is attached is in the public right-of-way or within view of the public right-of-way. As a result, regulators may limit or prohibit such use of dynamic displays through regulations or laws. Furthermore, changing the dynamic display in a location or manner that might be visible to other drivers may give rise to potential claims of responsibility for an accident if those drivers allow themselves to become distracted by the display (although it is generally each driver's responsibility to pay attention to the job of driving their own vehicle). Therefore, some embodiments described herein provide for a dynamic display on a FHV that is configured to change displayed information when conditions are satisfied that are configured to conform to regulations, decrease a likelihood of distraction, reduce unsafe driving conditions, and the like. The conditions for dynamic content or changing content can include, for example, when the FHV is located in a designated or suitable transition location or situation. A designated or suitable transition location can be any location that reduces the likelihood that other drivers may allow themselves to become distracted by a changing or animated message on a dynamic display. For example, designated or suitable transition locations can include, without limitation, parking lots, quiet streets, alleys, anywhere the FHV stops, locations off of the public right-of-way, taxi stands, airports, hotels, or other similar locations. A designated or suitable transition situation can include, for example, picking up or dropping off a fare or being stopped at a stop light or stopped in traffic. As another example, designated or suitable transition situations can also be based at least partly on a speed of the FHV, surrounding traffic conditions, emergency situations, an operational state of the FHV, a transmission mode of the FHV, and the like.

In accordance with some embodiments, a FHV is provided having a dynamic display system configured to change displayed information or display dynamic content when transition conditions are met. The transition conditions can be based at least in part on traffic laws, regulations, safety considerations, and the like. The FHV display system can determine it is safe when the FHV is in a suitable location or meets other criteria that reduce a probability of violating a law or of other drivers being distracted. The FHV display system can be configured to process information about the FHV, including its location and speed. If the transition conditions are met, the FHV display system can change the displayed information or display dynamic content (e.g., animations or video). In some embodiments, the FHV display system includes a notification system configured to alert the FHV operator that a display change is requested or warranted. The notification system can include information about suitable transition locations near the position of the FHV. The notification system can include information about methods of satisfying other transition conditions, such as actions the operator of the FHV can take to satisfy those conditions.

In accordance with some embodiments, a display management system associated with a FHV is provided that includes a transition module that is configured to determine when to change displayed information. The determination can be based at least in part on safety considerations, legal considerations, regulatory considerations, advertiser considerations, and message parameters. Message parameters can include a time of day and/or a geographical location, for example. Satisfying the transition conditions can include navigating to a suitable location, stopping the FHV, leaving the public right-of-way, positioning the FHV such that the dynamic display is occluded from the view of other drivers, and the like. The display management system also includes a vehicle data module that is configured to provide properties related to the FHV, such as its location and speed. The display management system also includes a display data module configured to control a display on the FHV and to change the displayed information when the transition module indicates that transition conditions have been satisfied and a change is requested or warranted. In some embodiments, the display management system is configured to determine an appropriate message to be displayed when picking up a fare, wherein the appropriate message is chosen based at least in part on a planned travel route and/or a payment associated with the message. In some embodiments, the display management system is configured to increase or maximize ad revenue when the FHV has no fare by selecting a message to be displayed and by indicating to the operator of the FHV suggested driving parameters (e.g., speed, travel route, etc.) and/or suggested waiting locations.

In accordance with some embodiments, a tracking system is provided that is configured to receive data display information from a plurality of FHVs. The tracking system is configured to receive this information to determine locations where display changes occur and with what frequency. The tracking system is configured to receive this information to determine conditions which result in display changes. The tracking system is configured to statistically analyze this information to determine statistical properties related to display changes. In some embodiments, the tracking system determines a probability of a defined number of FHVs changing a display as a function of input criteria such as location and/or time. In some embodiments, the tracking system compiles a list of suitable transition locations where transition conditions are satisfied.

### BRIEF DESCRIPTION OF THE DRAWINGS

Various embodiments are depicted in the accompanying drawings for illustrative purposes, and should in no way be interpreted as limiting the scope of the inventions. In addition, various features of different disclosed embodiments can be combined to form additional embodiments, which are part of this disclosure. Throughout the drawings, reference numbers may be reused to indicate correspondence between reference elements.

FIG. 1A illustrates an example embodiment of a FHV with a dynamic display unit controlled by a display management system that receives information from an on-board diagnostic system and a GPS system.

FIG. 1B illustrates an example embodiment of a FHV with a dynamic display unit wherein the display management system is remote from the FHV.

FIG. 1C illustrates an example embodiment of a FHV with a LED display unit and a notification system, both of which are controlled by a display management system.

FIG. 2 illustrates an example embodiment of a notification display configured to indicate proposed transition locations on a map.

FIG. 3A illustrates a block diagram of an example embodiment of a display management system.

FIG. 3B illustrates a block diagram of an example embodiment of a display management system that controls a notification system.

FIG. 3C illustrates a block diagram of an example embodiment of a display management system that receives information from a remote vehicle data system and remotely controls a display system.

FIG. 4 illustrates a flow chart of an example method for determining when to change displayed information on a FHV display system.

FIG. 5 illustrates a block diagram of data flow in a data management system configured to select a message to display and to transition messages when transition conditions are satisfied.

FIG. 6 illustrates a block diagram of an example embodiment of a tracking system configured to determine statistical properties of changes in displayed information across a plurality of FHV display data systems.

### DETAILED DESCRIPTION

The embodiments of the disclosure and the various features and details thereof are explained more fully with the reference to the non-limiting embodiments and examples that are described herein and/or illustrated in the accompanying drawings. It should be noted that the features of one embodiment may be employed with other embodiments as the skilled artisan would recognize, even if not explicitly stated herein. Descriptions of well-known modules and computing techniques may be omitted so as to not unnecessarily obscure the teaching principals of the disclosed embodiments. The examples used herein are intended merely to facilitate an understanding of ways in which the disclosure may be practiced and to further enable those skilled in the art to practice disclosed embodiments. The examples and embodiments herein should not be construed as limiting. Throughout this disclosure, reference is made to transitioning messages on a dynamic display. This can refer to displaying a first message and subsequently displaying a different message. In addition, this can refer to displaying a message with dynamic content, such as a video or animation. Accordingly, nothing in the following description should be construed to limit any of the embodiments to being used with a dynamic display system that solely transitions from one static message to another static message, but the embodiments encompass dynamic message content. Therefore, where transition conditions are described it should be understood that these conditions apply to displaying dynamic content in addition to changing between static messages.

Unless explicitly indicated otherwise, terms as used herein will be understood to imply their customary and ordinary meaning. For example, the term “messages” is a broad term and is to be given its ordinary and customary meaning to a person of ordinary skill in the art (e.g., it is not to be limited to a special or customized meaning), and includes, without limitation, text, images, audio, video, animations, colors, designs, sounds, lights, and the like configured to convey information or content to an observer.

Overview

FHVs can include displays on the tops, sides, or trunks of the vehicle. FHV operators, advertisers, media companies, and the like that provide advertising solutions for FHV media advertising displays can use dynamic LED displays. Using dynamic displays on FHVs can result in selling more advertising per display and generating more income per display due at least in part to the ability to quickly and repeatedly change what is displayed. For example, the dynamic FHV display described herein can allow advertisers to design campaigns that target ads at different times of day and/or at specific geographic locations within a city. Such advertisements being more targeted in time and location may be more valuable than static displays and therefore could be sold for a greater time-unit price. The sum of these time-unit prices that could be obtained by the FHV media company using dynamic displays for a given period may be greater than the time-unit price for comparable static advertisements over the same period.

As an example, an advertiser may be interested in displaying an advertisement for an entertainment option that is available for a fixed time and/or at a specific location, such as a night club. The advertiser can choose to display the advertisement for the night club only after a determined time of day (e.g., 1-2 hours before the night club opens) and only in a determined geographic area (e.g., an area proximate to the night club). This type of time- and/or location-targeted advertising can increase the effectiveness of the advertisement. An increase in efficacy can provide more return on the advertiser's investment in purchasing display time for the advertisement and/or allow the FHV operator to sell the advertising space for a greater amount compared to non-targeted advertising.

However, drivers of other vehicles may allow themselves to be distracted by mobile dynamic displays. Their use on city streets and county, state, and federal highways, in addition, may be regulated by transportation, highway, and traffic laws whose interpretation can govern whether and what types of mobile dynamic displays can be mounted on FHVs. Furthermore, even if some types of mobile dynamic displays are permitted, automobile tort liability may prevent wide adoption of LED displays that involve intermittent light, character movement, or copy or graphics changes while the vehicle is operating within the public right-of-way. Therefore, some embodiments described herein provide for dynamic media displays on FHVs that are configured to change display when satisfying transition conditions that are configured, at least in part, to reduce or limit potential distraction to other drivers, to abide by regulatory requirements, and/or to reduce possible tort liability. The transition conditions can incorporate safety considerations as well as other conditions related to advertising concerns, as described in greater detail herein.

Some embodiments disclosed herein provide for technology that automatically changes the message being displayed on the dynamic display when the FHV is in a safe location (e.g. when the taxicab is at a taxicab stand, a quiet street, stopping to drop off a customer etc.) or satisfies other transition conditions (e.g., stopped, off of the public right-of-way, at a stop light, in a parking structure, on private land, in an emergency situation, etc.). The automatic change in the message displayed can occur without direct driver input to the display. For example, the message can change when the display system determines that conditions are appropriate without requiring the operator to provide input to cause the message to change. Existing global positioning systems (“GPS”) and on-board diagnostics (“OBD”) port monitoring technology can be used to inform either an onboard program or a remote server carrying the display-change instructions that an acceptable display-change condition has been met. In some embodiments, the technology can include a notification system configured to inform an operator of the FHV that a change in the dynamic LED display's copy or features has been requested or is warranted so that the operator can maneuver the FHV to satisfy a transition condition for changing the display. For example, when a time scheduled for a change of the digital display arrives, the notification system can notify the FHV operator so that when the operator sees a convenient place to pull over, the operator can do so to permit the display to change. In some embodiments, there are different levels of urgency regarding the timing of the change. The advertiser can pay more for a higher urgency, resulting in action being taken more promptly by the operator, thereby causing the display to change more promptly.

Some embodiments disclosed herein provide for a tracking system configured to provide information related to FHV display changes across a plurality of FHV displays. The tracking system may advantageously be configured to collect information related to satisfaction of safety conditions to compile a list of safe or suitable transition locations. The list of transition locations can be provided to operators of FHVs through a notification system. The tracking system can also be configured to construct statistical models for defined geographic locations that predict the time necessary to change the displays of a defined number of FHVs. For example, the tracking system can be configured to use data about satisfaction of safety conditions, such as the frequency of FHVs stopping off the roadway to pick up or drop off fares, as well as other known factors to construct the statistical models. The statistical models can allow a media company to determine a likely number of FHVs displaying defined information given a set of criteria. For example, based at least partly on the statistical models, the media company can predict how long it would take a desired number of FHVs to change their displays to a requested message. This can allow the media company to sell FHV media advertising more effectively than when selling advertising media for static displays because the media company can target advertising to targeted customers. For example, static displays typically can be purchased for periods of weeks or months around and during a show, event or a product or service offer. It may be undesirable to sell advertising for shorter periods of time due at least in part to the time and labor to change out scores or hundreds of displays on FHVs that may be located at different base operations and under different ownership. In contrast to static displays, the dynamic displays may advantageously be configured to display a plurality of messages, targeting particular messages according to location and/or time of day. These targeted advertisements are more valuable to advertisers and may result in more revenue for the media company. In addition, the media company can display other messages during other times and/or at other locations. These other messages generate revenue for the media company as well. As a result, the total revenue over a given time period can be greater because of the premium that can be charged for targeted advertising when compared to static advertising. In some embodiments, the tracking system is configured to keep a record of when and where the display is changed for purposes of monitoring value received by the advertiser. In some embodiments, the tracking system may advantageously be configured to record the route travelled by the FHV while the ad is being displayed and when the ad changed out. This information can be reported back to the advertiser and/or can be used to calculate a fee for displaying the advertisement.

FHV with Dynamic Display

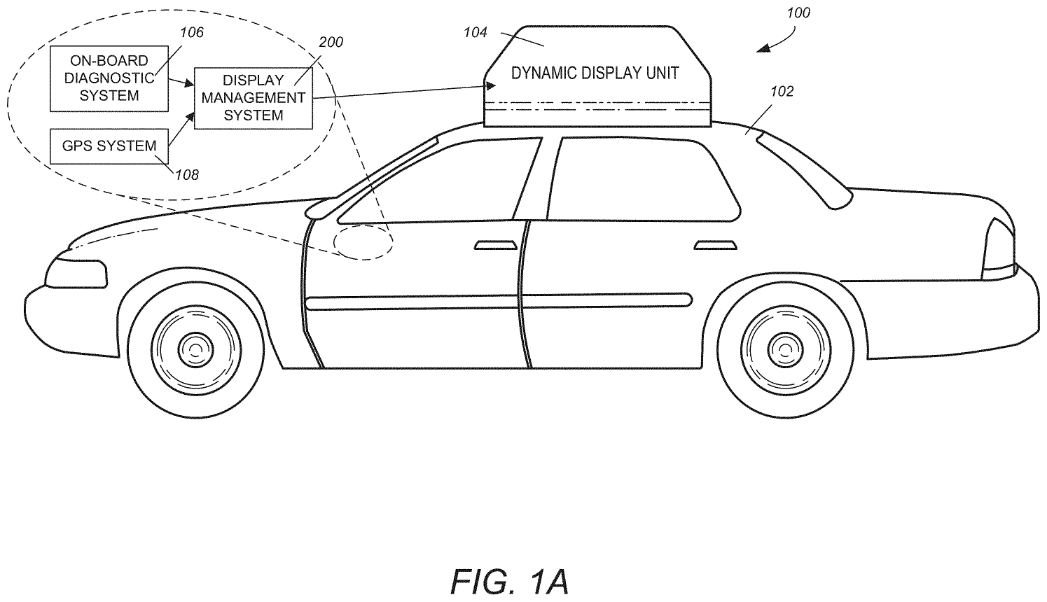

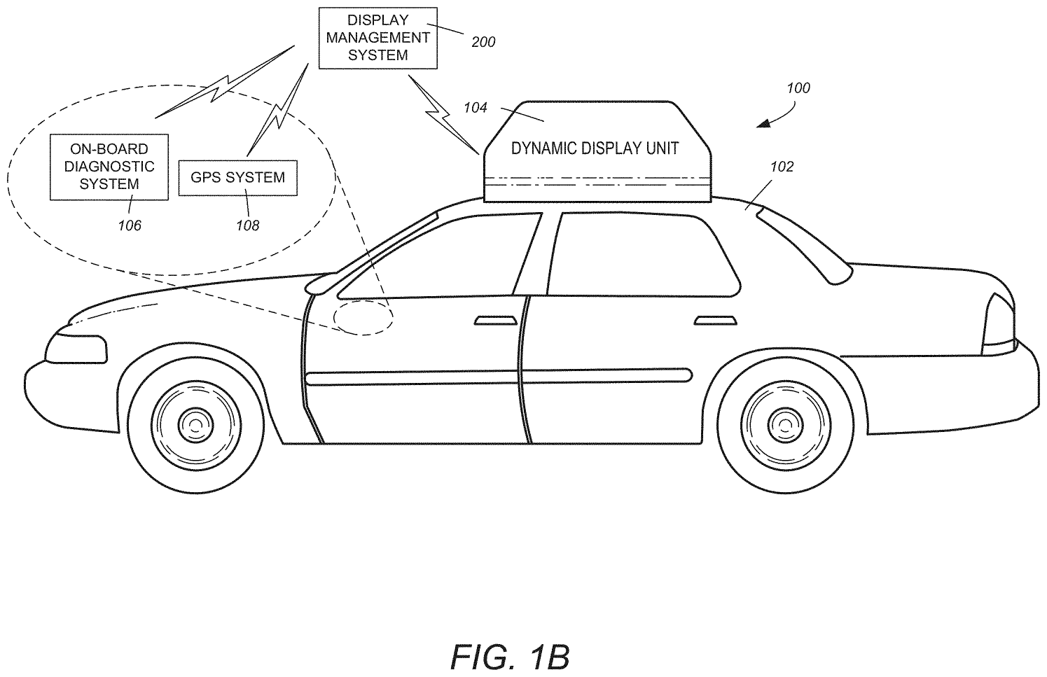

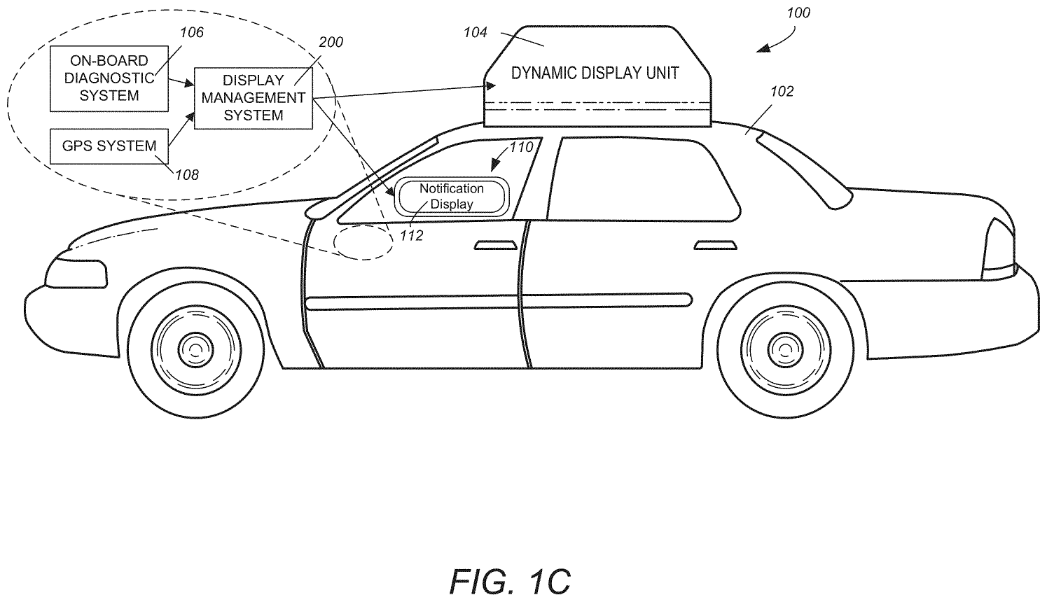

FIG. 1A illustrates an example embodiment of a mobile display system 100 comprising a FHV 102 with an electronic display unit 104 (e.g., a LED display) controlled by a display management system 200 that receives information from an on-board diagnostic system 106 and a GPS system 108. The mobile display system 100 may advantageously be configured to automatically change displayed information on the display 104 subject to safety or other transition conditions that can be based at least in part on a location and/or speed of the FHV 102. The transition conditions can be configured to conform to statutory or regulatory requirements and/or to reduce or minimize a potential likelihood of other drivers becoming distracted. For example, transition conditions can be satisfied where the FHV 102 is stopped, where the FHV 102 is driving along a non-public road, where the FHV 102 is at a designated location and is stopped, when the FHV is off of the public right-of-way, when the FHV is out of view of drivers on the public right-of-way, or any combination of these conditions or similar conditions as described more fully herein.

The mobile display system 100 includes the FHV 102 which can be any vehicle configured to support a dynamic display, such as the electronic display unit 104. For example, the FHV 102 can be a taxi, limo, shuttle, bus, car, truck, and the like. The display unit 104 can be attached to the FHV 102, such as on the roof (as shown), on the sides of the vehicle, on the trunk, or on another location of the FHV 102. The display unit 104 can be any LED display or other electronic display configured to display information that is capable of changing over time such as LCD-based displays, CRTs, rotating signs, rolling ads, etc. The display unit 104 can be configured to present text, images, video, animations, audio, lights, colors, designs, and the like.

The mobile display system 100 includes the display management system 200 configured to control the information displayed on the display unit 104. The display management system 200 can be local to the FHV 102, such as a device that sits within or is coupled to the FHV 102 (as shown), or it can be remote relative to the FHV 102, such as a remote server that wirelessly communicates control commands to the display 104, an example of which is illustrated in FIG. 1B and described in greater detail herein. In some embodiments, the display management system 200 is an electronic device that is located within or on the FHV 102. In some embodiments, the display management system 200 is a software application or program that runs on an electronic device or multiple devices such as, for example, a computer, a server, a computer network, a laptop, a smartphone, a PDA, or the like. The display management system 200 can be configured to control the display 104 through wireless or wired communication.

The display management system 200 may advantageously be configured to communicate with or receive information from an on-board diagnostic (“OBD”) system 106. The OBD system may advantageously be configured to gather, determine, or calculate information related to the vehicle and make this information available to other systems. For example, the OBD system 106 can provide the display management system 200 with information about the FHV 102 that includes, without limitation, speed, operational state (e.g., whether the ignition is on, whether the engine is running, etc.), transmission mode (e.g., whether the FHV 102 is in neutral, park, or another gear), or the like. The display management system 200 can use the information from the OBD system 106 to determine whether safety and/or other suitable transition conditions have been satisfied before changing the display 104. The OBD system 106 can be any system suitable for providing vehicle information to the display management system 200. The OBD system 106, for example, can be an integrated part of the FHV 102 (e.g., an OBD-II-compatible system having a data link connector located in the vehicle), it can be an electronic device that is not integrated with the FHV 102, such as an electronic device in or on the FHV 102, or it can be a system or collection of electronic devices or systems that are configured to communicate with other on-board systems and/or non-OBD systems. The OBD system 106 can be configured to communicate with the display management system 200 wirelessly, through wired connections, or both.

The display management system 200 can be configured to communicate with or receive information from a GPS system 108. The GPS system 108 can provide the display management system 200 with information about a location and/or a speed of the FHV 102. The GPS system 108 can be any suitable electronic device configured to provide a location to the display management system 200 and may provide that information without using the global positioning system. The display management system 200 can use the information received from the GPS system 108 to determine whether it is safe to change the display 104, such as when the FHV is in a safe transition location, off the public right-of-way, or at some other suitable location. Suitable locations can include, for example, locations where the FHV is occluded from the view of other drivers and/or in a location where other drivers are less likely to allow themselves to be distracted by dynamic display content. The display management system 200 can use the location information from the GPS system 108 to determine which message is suitable, desirable, or requested for display such as when an advertiser indicates that a message be displayed within a geographical location.

FIG. 1B illustrates an example embodiment of the mobile display system 100 wherein the OBD system 106, the GPS system 108, the display 104, and the display management system 200 communicate wirelessly with one another. The display management system 200 can be remote in relation to the FHV 102, such as at a remote location and/or in a fixed location. The display management system 200 may advantageously be configured to receive information from the OBD system 106, the GPS system 108, and/or the display 104 and control the display 104 based at least in part on the information received, wherein control occurs from a remote location such as a headquarters for a media company, a computer server location, or other similar location. The display management system 200 may advantageously be configured to handle multiple FHVs 102 and control the displays 104 for each based at least in part on the information each FHV 102 transmits to the display management system 200. Wireless communication can occur using any standard wireless communication standard, method, or protocol. For example, the display management system 200 can communicate with the display 104 using RF signals transmitted according to the IEEE 802.11 standard, including IEEE 802.11(a), (b), (g), or (n). As another example, wireless communication can be accomplished using protocols that conform to BLUETOOTH™ Specification Version 3.0+HS adopted in 2009. As another example, wireless communication can be accomplished using methods or protocols such as CDMA, GSM, AMPS or other known methods or protocols that are used to communicate within a wireless cell phone network. Proprietary wireless communication protocols can also be used. It is to be understood that the display management system 200 can be local to a particular FHV 102 and the components of the mobile display system 100, including the display management system 200, can be configured to communicate wirelessly with each other using the standards, methods, or protocols described above.

FIG. 1C illustrates an example embodiment of the mobile display system 100 comprising the FHV 102 with the electronic display unit 104 and a notification system 110, wherein the display unit 104 and the notification system 110 are controlled by the display management system 200. The notification system 110 may advantageously be configured to present an operator of the FHV with information related to the display 104, such as when a display change has been requested or is warranted. Communication with the notification system 110 can be accomplished through wired or wireless means using standardized and/or proprietary protocols.

The notification system 110 can be configured to receive a notification from the display management system 200 that a change in the display is requested and/or warranted. The notification system 110 can alert the operator of the FHV 102 using a visual and/or audible cue that the display 102 will change automatically when display-change conditions are satisfied. The conditions can be related to properties of the FHV 102 such as speed, location, transmission mode, operational status, or any combination of these properties. The conditions can be configured to increase safety, to decrease a likelihood that other drivers become distracted by message changes, to comply with regulatory rules or guidelines, to comply with traffic laws, or any combination of these. In response to the notification, the operator can maneuver or control the FHV 102 to satisfy the display-change conditions, thereby providing appropriate conditions for the display 104 to change the message automatically, without input from the operator.

In some embodiments, the notification system 110 can include a notification display 112 that presents information to the operator. The information presented to the operator can include suggested transition locations, a time frame for changing the display, a geographical region for the display change, safety conditions that can be satisfied and/or how they may be satisfied, directions to a nearest suggested transition location, an urgency or priority associated with the display change, or any combination of these. In some embodiments, the advertiser providing the information to be displayed can pay an increased price to increase a priority or urgency indicated to the driver, thereby resulting in a more prompt display change. In some embodiments, once the operator has satisfied display-change conditions and the display unit 104 has changed, the notification system 110 can notify the operator that the change was successfully made.

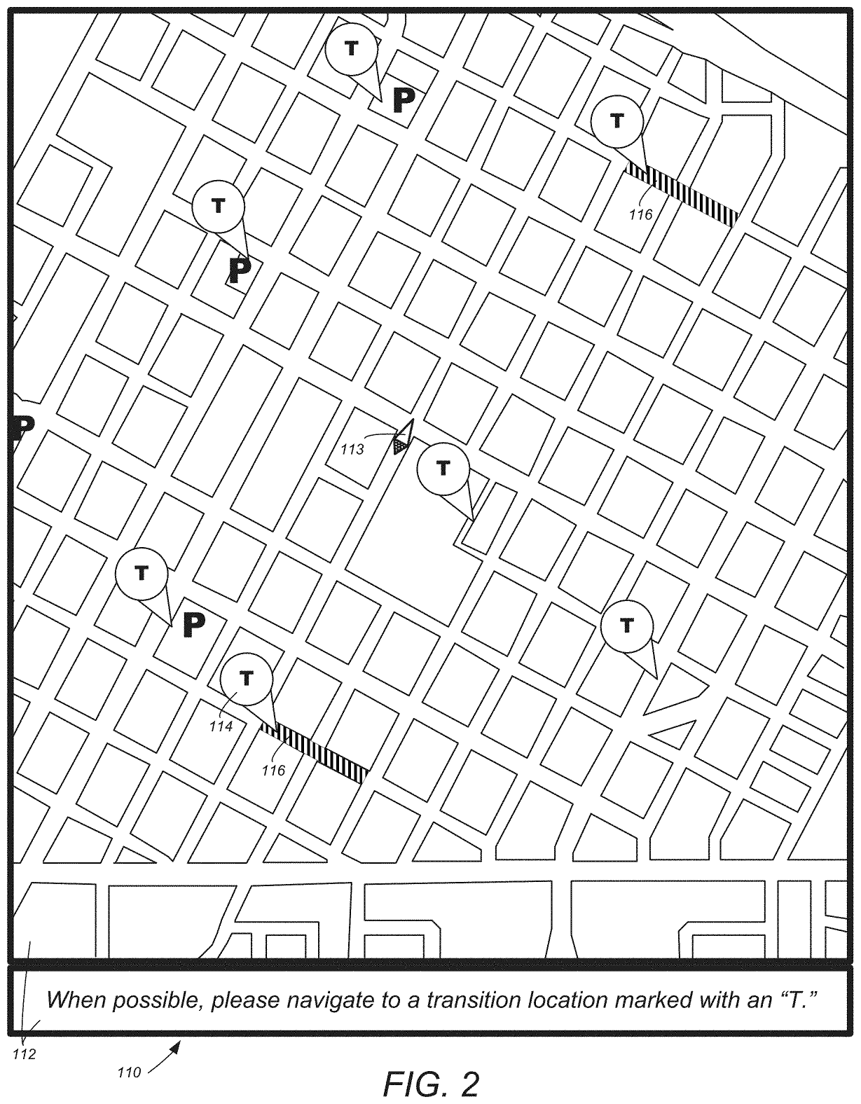

FIG. 2 illustrates an example embodiment of a notification display 112 configured to indicate transition locations 114 on a map. The notification display 112 may advantageously be configured to alert the operator that a display change is requested along with appropriate, proposed, or suggested transition locations 114. The locations 114 can be shown relative to the location of the FHV 113. Navigation instructions can be presented to the operator to facilitate satisfaction of the display-change conditions. In some embodiments, display-change conditions can be satisfied when driving on defined roads which can be indicated using safe road indicators 116 on the notification display 112. In some embodiments, the safe road indicators 116 can be off of the public right-of-way, such as on private roads or property, or on secluded roadways, such as alleys or single lane one-way streets. The notification system 110 can present information to the operator visually using the notification display 112 or audibly. In some embodiments, while en route with a fare to a destination, the notification system 110 can illustrate a route to the operator that will not increase time traveled or increase the fare but that will increase ad revenue. In some embodiments, when the FHV is without a fare, the notification system 110 can indicate a suggested route to travel and a speed to drive along the suggested route, the suggestions being configured to increase or maximize ad revenue while the FHV operator is without a fare.

### Display Management Systems

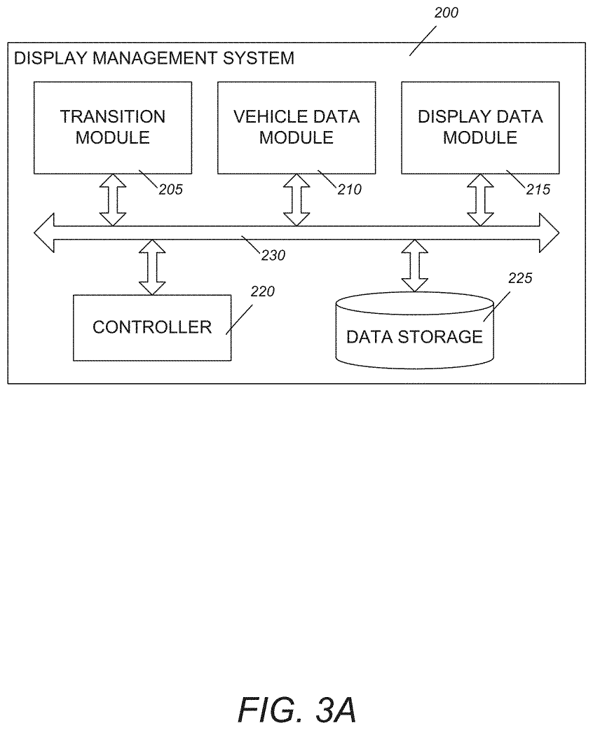

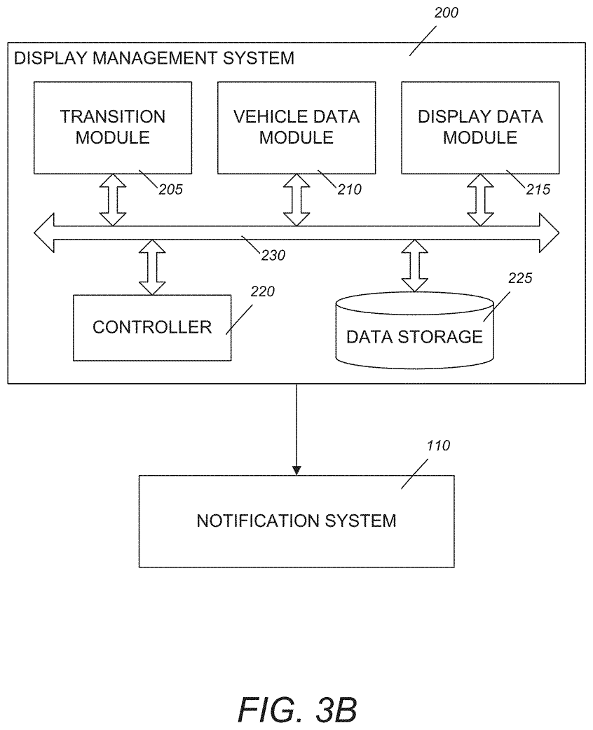

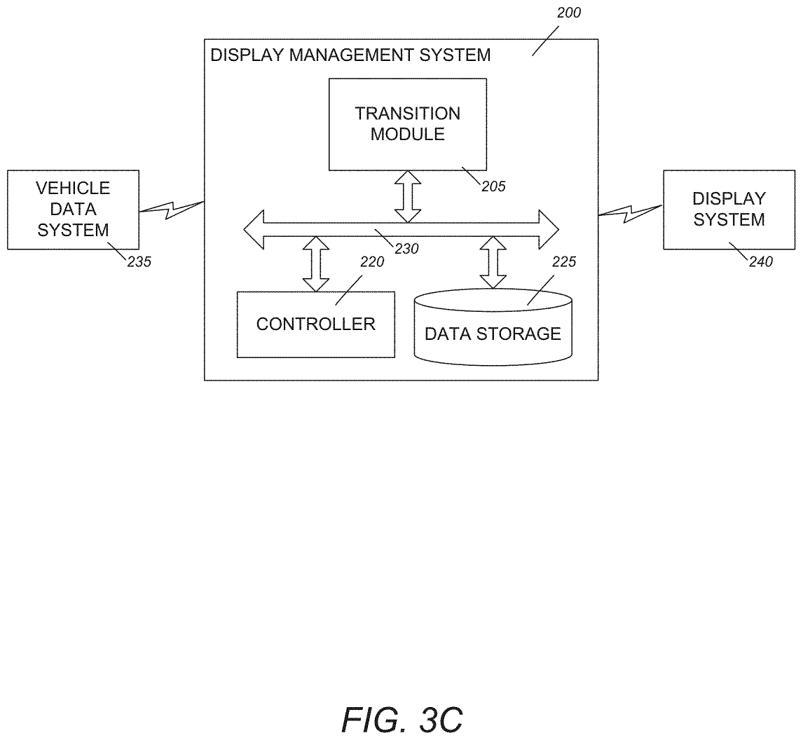

FIG. 3A illustrates a block diagram of an example embodiment of a display management system 200. The display management system 200 can include hardware, software, and/or firmware components used to control the display 104 and to determine when conditions are satisfied to change a display 104 and. The display management system 200 may advantageously be configured to receive information from various systems or modules, to determine when it is safe or appropriate to change the display 104, to send a notification to an operator that a change in the display 104 is requested, to identify a suggested location to change where the display 104 can change automatically, to store vehicle data, and the like. The display management system 200 can include a transition module 205, a vehicle data module 210, a display data module 215, a controller 220, and data storage 225. Components of the display management system 200 can communicate with one another, with external systems, and with other components of the mobile display system 100 over communication bus 230.

The display management system 200 includes the vehicle data module 210 configured to generate, provide, receive, collect, compute, and/or determine properties of the FHV 102, such as speed, position, location, operational state, transmission mode, and the like. The vehicle data module 102 can receive information from various systems, such as and OBD system, a GPS system, and the like. The vehicle data module 102 can use the controller 220 to process this information and communicate the processed information to the transition module 205. In some embodiments, other sensors (e.g., photosensors, image sensors, audible sensors, thermal sensors, etc.) can send information to the vehicle data module 210 that indicate a presence, location, or quantity of other vehicles or persons near the FHV 102. This information can be used by the transition module 205 to determine whether certain transition conditions related to safety are satisfied. For example, if the other sensors indicate that there are fewer than a threshold number of non-stationary vehicles within a buffer zone, the transition module 205 can determine that conditions related to safety have been satisfied. The buffer zone can be defined as a radius from the display 104 wherein other drivers are less likely or not likely to allow themselves to be distracted by message changes and/or dynamic messages. The buffer zone can be, for example, a radius of about 5 feet, about 10 feet, about 25 feet, about 50 feet, about 100 feet, or about 500 feet. The threshold number of non-stationary vehicles within the buffer zone can be, for example and without limitation, 20 or fewer, 10 or fewer, 5 or fewer, 4 or fewer, 3 or fewer, 2 or fewer, 1 or fewer, or 0. The buffer zone can be detected through the use of one or more sensors that provide, for example, image data, sound data, thermal data, proximity data, and the like. Examples of sensors can include image sensors, thermal sensors, microphones, sonar systems, radar systems, laser range finders, and the like.

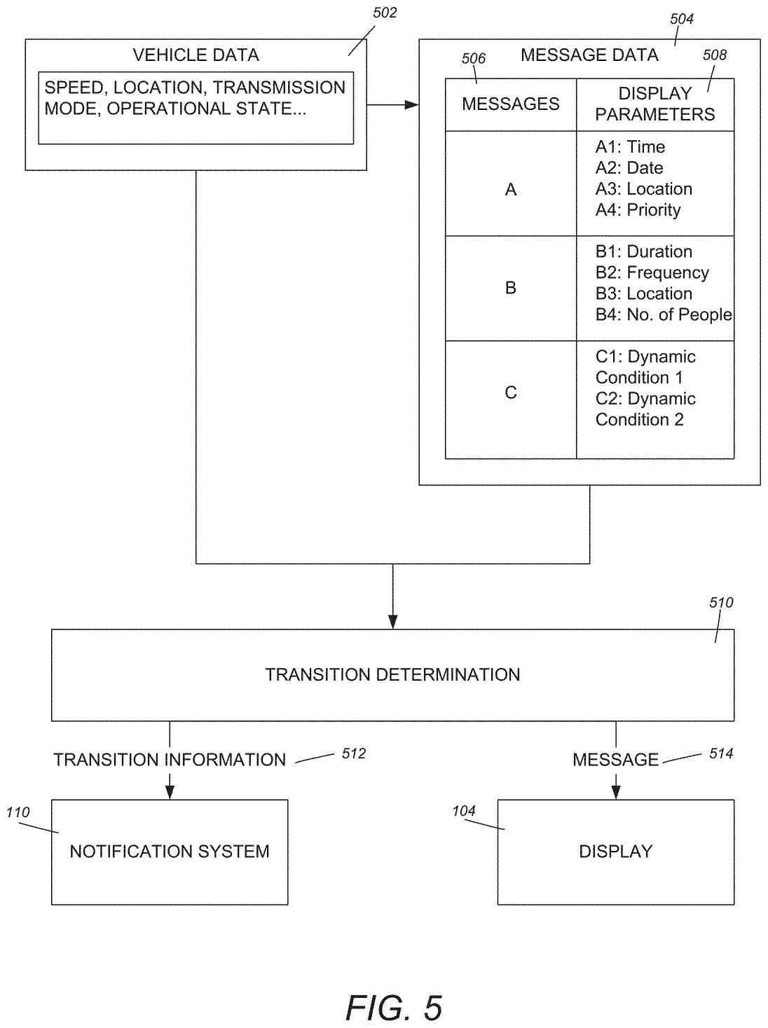

The display management system 200 includes the display data module 215 that generally controls the display 104 and manages the messages to be displayed. The display data module 215 can generate or retrieve messages and associated message parameters that are used to decide which messages to display and under what circumstances to display them. For example, the display data module 215 can generate or retrieve a list of messages, each message having one or more associated message parameters. In some embodiments, the display data module 215 sends the message list and associated parameters to the transition module 205, which can then decide which message to display and whether the message can be displayed based on transition and/or safety conditions. In some embodiments, the display data module 215 determines which message to send based at least in part on an analysis of the associated message parameters for each message. The associated message parameters can include conditions or directives used to select an appropriate message for display. Message parameters can include, for example, time of day, date, location, duration of display, frequency of display, priority, fees, associated revenue, or other such parameters as described in more detail with reference to FIG. 5.

The display data module 215 can be configured to control the display 104, to retrieve or to generate associated message parameters for displaying information, and/or determining which message to display. For example, an advertisement can be commissioned to be displayed at a defined time of day. The display data module 215 can retrieve an appropriate message, based at least in part on the time of day, from an external system or from data storage 225 and send the retrieved message to the transition module 205. As another example, a message can be commissioned to be displayed within a defined geographical area. The display data module 215 can retrieve an appropriate message, based at least in part on a location of the display 104, from an external system or retrieve this information from data storage 225 and send the retrieved message to the transition module 205. In some embodiments, the display data module 215 manages the messages and message parameters and sends a list of messages with their associated parameters to the transition module 205 wherein the transition module 205 determines which messages to display. The display data module 215 can be configured to receive or obtain messages to be presented with the display 104, such as text, images, video, audio, designs, colors, and the like. If the display data module 215 receives from the transition module 205 an indication that it is acceptable to change the display 104, the display data module 215 can be configured to control the display 104 to display the appropriate message. The display data module 215 can be configured to communicate with the data storage 225 or with an external system to retrieve or obtain messages to be displayed and their associated message parameters.

The display management system 200 includes the transition module 205 configured to manage when the display 104 can display dynamic content and/or when the display 104 can change a message being displayed. In some embodiments, the transition module 205 is configured to manage the display 104 based primarily on safety or regulatory considerations, allowing the display 104 to change messages or display dynamic content when it is safe, legal, and/or not in violation of regulatory rules. In some embodiments, the transition module 205 determines which message to display and/or whether to change the message displayed based at least in part on a combination of safety considerations and message parameters, as described in greater detail herein. In some embodiments, the transition module 205 determines a course of action to be taken to satisfy transition conditions based at least in part on a difference between current vehicle conditions and target vehicle conditions, the target vehicle conditions being based at least in part on safety considerations, legal considerations, regulatory considerations, message parameters, or any combination of these.

The transition module 205 can be configured to determine whether to change a displayed message. The determination can be made based on a variety of information related to the vehicle, the content of the message, message parameters, safety considerations, legal considerations, regulatory considerations, and the like. For example, the transition module 205 can receive vehicle data from the vehicle data module 210 and message parameters from the display data module 215. The transition module 205 can then process the received vehicle data to determine whether safety conditions, and/or message parameters have been satisfied. If so, the transition module 205 can communicate with the display data module 215 to change the displayed message.

For example, the message parameters can be satisfied where an advertiser has requested that an advertisement be displayed when the FHV 102 is within 1 mile of a retail establishment and the time is after 1 pm. The transition module 205 can receive the time and location parameters (e.g., within 1 mile of the store location and after 1 pm) from the data display module 215. The transition module 205 can process vehicle information received from the vehicle data module 210 to determine when it is after 1 pm and when the FHV 102 is within 1 mile of the retail establishment. If the transition module 205 determines that the message parameters are satisfied and that safety conditions are met, it will indicate to the display data module 215 to change the display. The display data module 215 can retrieve the message to be displayed from data storage 225, from a remote server, or from the transition module 205, and control the display 104 to display the message. As an example of the safety conditions, the transition module 205 can indicate that it is acceptable to change the display when the FHV 102 is at a taxi stand, a quiet street (e.g., a street with no other vehicles within sight of the FHV, or a street where a number of moving vehicles is less than a threshold number), stopping to drop off a customer, stopping to pick up a customer, off of a public right-of-way, out of sight of a public right-of-way, is located next to less than a threshold number of cars within a buffer zone, and the like.

In some embodiments, the display management system 200 is configured to determine an advertisement to display that increases or maximizes ad revenue for a defined route. For example, when the FHV 102 picks up a fare and receives a destination, the destination can be entered into the display management system 200. The display management system 200 can use the display data module 215 to determine the ad to display that would increase or maximize revenue along the planned travel route. The display management system 200 can base this determination at least in part on stores or other commercial establishments along the route, a time of day, predicted demographic along the route, and the like. Once the message to display is determined, the transition module 205 can indicate that it is acceptable to change the message (e.g., because the FHV is stopped, off the public right-of-way, not within view of other drivers, etc.) and the display data module 215 can change the display 104 to show the determined message.

In some embodiments, the display management system 200 is configured to change advertisements during a fare. The display management system 200 can use the transition module 205 to determine when the FHV 102 will be at a suitable transition location (e.g., along a quiet road), satisfy message parameters (e.g., within a designated geographical region), and/or satisfy safety conditions (e.g., stopped at a traffic signal) along the planned route. Based at least in part on this information, the display management system 200 can change messages at the appropriate time and location. This can increase advertisement-related revenue without impermissibly increasing fares, travel times, or both. The display management system 200 can also determine a possible alternative route that satisfies safety conditions and message parameters where the possible alternative route does not significantly increase a fare, a travel time, or both. In some embodiments, alternative routes can be selected and the patron can receive a credit or refund for any increase in fare due to the change in route. Thus, the display management system 200 can determine whether to change an advertisement during a fare, possibly increasing ad revenue.

In some embodiments, the display management system 200 is configured to determine a navigation route or navigation instructions that increases ad revenue when the FHV 102 has no fare. For example, after dropping off a fare, the operator FHV can choose to navigate to a location to find another fare. The display management system 200 can indicate a suggested route to the location that increases or maximizes ad revenue. For example, the display management system 200 can indicate that a path through a shopping center parking lot would increase ad revenue. Based at least in part on the suggested navigation instructions, the display management system 200 can choose an advertisement that increases or maximizes ad revenue.

In some embodiments, the display management system 200 is configured to navigate an automated vehicle having a display system 104. The display management system 200 can navigate the automated vehicle to a defined suitable transition location when a display change is requested and/or warranted. The display management system 200 can control the automated vehicle such that transition conditions (e.g., safety conditions and/or message parameters) are satisfied so that a display change can automatically occur. In some embodiments, the display management system 200 can control the automated vehicle in such a way as to increase or maximize ad revenue as a result of a navigation path and/or a frequency or timeliness of a change in displayed information.

The display management system 200 includes the controller 220 configured to interact with the modules, data storage 225, external systems, and other components of the FHV 102. The controller 220 can include one or more physical processors and can be used by any of the other components, such as the transition module 205, to process information. The display management system 200 includes data storage 225. Data storage 225 can include physical memory configured to store digital information and can be coupled to the other components of the display management system 200, such as the controller 220, the transition module 205, the vehicle data module 210, and the display data module 215.

FIG. 3B illustrates a block diagram of an example embodiment of a display management system 200 that controls a notification system 110. The display management system 200 can use the information from the transition module 205 to send a signal to the notification system 110 that a change in the display is desirable and that transition conditions have not been met. The display management system 200 can send information to the notification system 110 indicating possible ways to satisfy the transition conditions. The display management system 200 can send information to the notification system 110 regarding a priority or urgency of the change. This priority or urgency can be provided by the display data module 215, data storage 225, or a remote system. Once change conditions are met, the display management system 110 can send information to the notification system 110 that the change occurred. In some embodiments, navigation instructions, transition locations, and/or a map can be displayed on the notification display 112 of the notification system, as described herein with reference to FIG. 2.

FIG. 3C illustrates a block diagram of an example embodiment of a display management system 200 that receives information from a remote vehicle data system 235 and remotely controls a display system 240. The display management system 200 can be remote from the FHV 102 and or remote from the vehicle data system 235 and/or the display system 240. The remote display management system 200 can receive information from the vehicle data system 235 associated with the FHV 102 which can include information related to speed, location, operational state, transmission mode, or the like. The transition module 205 can process this information and determine whether transition conditions and/or message parameters have been satisfied. It can send this information to the display system 240, which can change the message on the display 104. Communication between the vehicle data system 235, the display management system 200, and the display system 240 can be wireless using radio frequency communication or other wireless communication technologies.

### Display Change Conditions

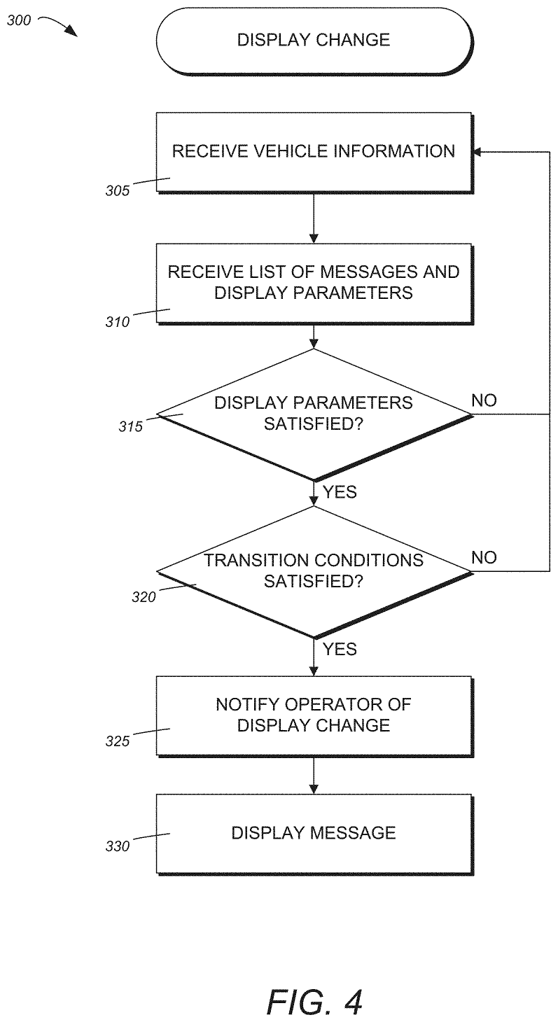

FIG. 4 illustrates a flow chart of an example method 300 for determining when to change a displayed message on a FHV display system 104. FIG. 5 illustrates a block diagram of data flow between components of a mobile dynamic display system when performing the method 300. For ease of description, the method 300 will be described as being performed by the display management system 200. However, one or more steps of the method 300 can be performed by modules within the display management system 200, the FHV display 104, components of the mobile display system 100, or any combination of these. Moreover, any individual step can be performed by any combination of systems, modules or components of the mobile display system 100 or other system described herein.

In block 305, the display management system 200 receives vehicle information. The vehicle information can include speed, location, operational state, transmission mode, and the like. In FIG. 5, the vehicle data 502 can be provided through an OBD system and/or a GPS system, as described herein with reference to FIG. 1. The vehicle data 502 can be combined with message data 504 and/or used in transition determination 510 to output a message for the display 104 and/or to output transition information to the notification system 110.

Returning to FIG. 4, the display management system 200 receives a list of messages and message parameters in block 310. As shown in FIG. 5, message data 504 includes messages 506 and display parameters 508. For each message 506, there can be one or more display parameters 508 which can be used to determine when to display the associated message 506. The display parameters 508 can include, for example, a list of times and/or locations associated with messages to be displayed, as illustrated in FIG. 5. For example, message “A” can include a list of display parameters “A1” to “A4” that include time parameters, data parameters, location parameters, and a priority. Thus, message “A” can be eligible for display if an appropriate combination of display parameters is satisfied. The display parameters 508 can include priorities associated with the messages 506, where a priority can be used to indicate to an operator of the FHV 102 an urgency or priority associated with a requested display change and/or it can be used to decide which message to display if more than one message is eligible for display. Some other examples of display parameters 508 include a duration of display (e.g., a total time a message should be displayed), a frequency of display (e.g., how often a message should be displayed), a probable number of viewers (e.g., predicted number of people who will see the message), a fee paid, predicted revenue, dynamic conditions (e.g., conditions that can be based on updated information from a centralized location or based on dynamic combinations of other parameters such as time and location), and other similar conditions. The display parameters 508 can be automatically generated, default parameters, negotiated by advertisers, or purchased by advertisers.

Returning to FIG. 4, the display management system 200 determines which messages from the received list have display parameters that are satisfied in block 315. If there is more than one, the display management system 200 can determine which message to display based at least in part on priority information, predicted revenue, fees paid, or any combination of these. The display management system 200 can use the information received in block 305 to determine whether the display parameters are satisfied.

Returning to FIG. 5, in some embodiments, determining which messages 506 have display parameters 508 that are satisfied can be performed prior to transition determination 510. For example, based at least in part on the vehicle data 502, the display management system 200 can determine which messages 506 have display parameters that are satisfied. This subset of messages can then be used in transition determination 510. In some embodiments, determining which messages 506 have display parameters 508 that are satisfied can be performed during transition determination 510. For example, all message data 504 and vehicle data 502 can be used in transition determination 510 to select which message or messages 506 are eligible for display.

Returning to FIG. 4, the display management system 200 determines whether transition conditions are satisfied in block 320. Transition conditions can be conditions associated with safety concerns, regulatory concerns, legal liability concerns, or other concerns. Transition conditions can be any combination of conditions associated with the FHV 102 to satisfy before automatically changing a display. The transition conditions can be based at least in part on speed and/or location of the FHV 102. For example, if the FHV 102 is stopped, the transition conditions may be satisfied. If the FHV 102 is on a street with relatively no traffic, the transition conditions may be satisfied. If the FHV 102 is in a parking structure or low-speed area, the transition conditions may be satisfied. Transition conditions can be programmed and/or customized according to a customer, an operator, an advertiser, regulatory requirements, statutory requirements, or the like. In some embodiments, transition conditions can be satisfied independent of the status, location, or speed of the FHV 102 or other vehicles where the dynamic display transitions from a first message to a second message sufficiently slowly to reduce a likelihood that other drivers allow themselves to be distracted by the changing display.

Returning to FIG. 5, transition determination 510 may advantageously be configured to incorporate safety considerations, regulatory considerations, statutory considerations, or other similar considerations when deciding whether to change messages on the display 104. Transition determination 510 can use vehicle data 502 in combination with static data (e.g., maps, rules, regulations, laws, etc.) and/or dynamic data (e.g., sensor data related to surrounding vehicles or people) to determine if a message change is acceptable. For example, a message change may be acceptable where there is fewer than a threshold number of non-stationary vehicles within a buffer zone defined as a zone having a radius extending from the display 104 to about 5 feet, about 10 feet, about 25 feet, about 50 feet, about 100 feet, or about 500 feet, wherein the radius is configured to reduce or eliminate a probability that other drivers allow themselves to be distracted by message changes and/or dynamic messages. The threshold number of non-stationary vehicles within the buffer zone can be, for example and without limitation, 20 or fewer, 10 or fewer, 5 or fewer, 4 or fewer, 3 or fewer, 2 or fewer, 1 or fewer, or 0. As another example, a message change may be acceptable where an average speed of neighboring vehicles is less than or equal to about 25 mph, less than or equal to about 20 mph, less than or equal to about 15 mph, less than or equal to about 10 mph, or less than or equal to about 5 mph. As another example, a message change may be acceptable where a speed limit is less than or equal to 25 mph, less than or equal to 20 mph, less than or equal to 15 mph, less than or equal to 10 mph, or less than or equal to 5 mph.

As another example, a message change may be acceptable where the display 104 is located off of a public right-of-way or a threshold distance from a public right-of-way. The threshold distance can be at least about 10 feet, at least about 25 feet, at least about 50 feet, at least about 100 feet, at least about 250 feet, or at least about 500 feet. As another example, a message change may be acceptable where the display 104 is not visible from a public right-of-way.

In yet another example, a message change may be acceptable when the display 104 is located within a designated zone. The designated zone may be defined by statute, by regulation, by law, or by some other governing body or instrument implemented to regulate the use of dynamic displays on vehicles. The designated zone may include, for example, parking lots, one way streets, alleys, drive ways, business entrances, taxi stands, airport drop-off or pick-up locations, and the like. Furthermore, a message change may be acceptable when during a designated time of day as defined by statute, regulation, law or other instrument. In one example, a designated zone can include a hotel driveway or parkway where taxis await customers or fares. When in this line, the dynamic display 104 can be used to display changing messages or dynamic content, such as video. If, for example, the hotel has a show that it would like to advertise, the hotel can pay for a video to be played on the display 104 when the taxi is parked in front of the hotel.

In yet another example, a message change may be acceptable when the FHV 102 complies with designated conditions. The designated conditions may be defined by statute, by regulation, by law, or by some other governing body or instrument implemented to regulate the use of dynamic displays on vehicles. The designated conditions may include, for example, a maximum speed of travel (e.g., less than 25 mph, less than 20 mph, less than 15 mph, less than 10 mph, less than 5 mph, etc.), an operational state (e.g., ignition on, ignition off, engine running, etc.), a transmission mode (e.g., neutral, park, reverse, etc.), and the like.

In yet another example, a message change may be acceptable when the message complies with designated conditions. The designated conditions may be defined by statute, by regulation, by law, or by some other governing body or instrument implemented to regulate the use of dynamic displays on vehicles. The designated conditions may include, for example, a content of the message, characteristics of the message (e.g., brightness, color, size, etc.), and the like.

Returning to FIG. 4, the display management system 200 controls a notification system 110 to notify the operator of a requested or warranted change in information to be displayed in block 325. The display management system 200 can include the priority information in the notification so that the notification system 110 indicates to the operator an associated priority or urgency. This can allow the operator to make a decision about attempting to satisfy transition conditions. In some embodiments, the display management system 200 can send transition information to the notification system 110 to notify the operator of possible locations or scenarios that would satisfy the transition conditions, as illustrated in FIG. 5. For example, transition determination 510 can determine a discrepancy between current conditions and conditions which would allow a message change. This discrepancy can be indicated to the operator of the FHV 102 along with suggested methods of satisfying transition conditions using transition information 512. Transition information 512 can include priority or urgency information. Transition information 512 can include map or navigation information to aid in satisfying transition conditions.

Returning to FIG. 4, the display management system 200 controls the display 104 in block 330 to display the appropriate message from the list of advertisements if the transition conditions and display parameters are satisfied. As illustrated in FIG. 5, transition determination 510 can output a message 514 for the display 104 when it is determined to be acceptable, based at least in part on satisfaction of transition conditions. The new message 514 can be displayed on the display 104 wherein the new message 514 is selected from the message data 504 using the display parameters 508. Thus, in some embodiments, the display management system 200 may advantageously be configured to only change messages or only display dynamic message content on the display 104 when display parameters 508 are met and when safety considerations, laws, or regulations allow for it. In some embodiments, the display management system 200 can be configured to prevent message changes where transition conditions are not satisfied wherein the transition conditions are based at least in part on laws, regulations, or other rules.

### Example Operation

To illustrate some principles of operation of the disclosed embodiments, an example will be described related to displaying and transitioning between messages on a dynamic display. This example is non-limiting and should not be construed to place limitations on the operation of the dynamic display and transition systems described herein.

A FHV can be equipped with a dynamic display configured to present dynamic content or content that changes over time. Advertising time can be purchased and message parameters can be attached to the purchased advertisements. For example, a hotel can purchase advertising time and elect to place time and location restrictions on the message. The hotel can choose to have the message displayed after 5 pm on weekends when the FHV is within 5 miles of the hotel. A movie theater can purchase advertising time where a movie with accompanying show times can be displayed. The message parameters can indicate that the message is to be displayed any time the FHV is within 1000 feet of a high school, mall, park, or the like. The locations can be defined by their GPS coordinates, for example. A soft drink company can pay for advertisements that run at any time and which run at least once every hour. Each of these companies can pay for additional priority so that when multiple messages are eligible for display, the display management system can select the most advantageous or profitable message to display.

When messages have been purchased, they can begin to be displayed on one or more FHVs. The display management system analyzes the list of messages that have been purchased along with the message parameters. The display management system can determine which message is appropriate to display based at least in part on satisfaction of the message parameters. For example, when the FHV nears the mall the display management system can determine that it would be appropriate to display the movie theater message. If the movie theater message is not currently being displayed, the display management system can determine whether it is safe to transition from the current message to the movie theater message. The transition conditions can be satisfied where the FHV is occluded from view of other drivers or where the FHV is on private property or off of the public right of way. For example, when the FHV is in the mall parking lot, the display management system may determine that it is safe to transition to the movie theater message. Once the display management system has determined that it is safe to transition and where the message parameters have been satisfied, the display can change to display the movie theater message.

### Example Tracking Systems

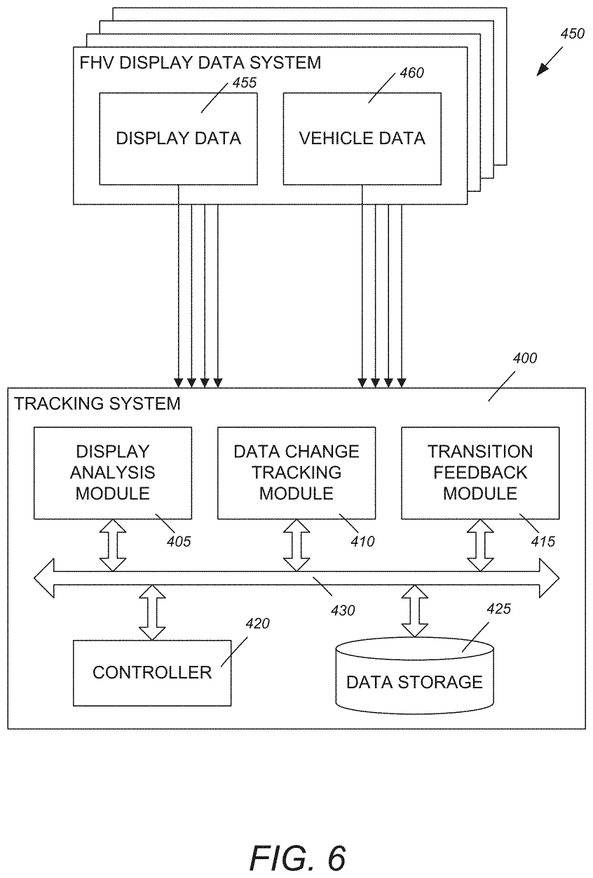

FIG. 6 illustrates a block diagram of an example embodiment of a tracking system 400 configured to determine statistical properties of changes in displayed information across a plurality of FHV display data systems 450. The tracking system 400 can include hardware, software, and/or firmware components used to monitor display data, to monitor vehicle data, and to track locations and/or times of display data changes. The tracking system 400 may advantageously be configured to receive information from various systems or modules, to determine where and/or when a display was changed, to track where and/or when a number of FHV changed their displays, to perform a statistical analysis on data change patterns, collect data regarding transition locations, and the like. The tracking system 400 can include a display analysis module 405, a data change tracking module 410, a transition feedback module 415, a controller 420, and data storage 425. Components of the tracking system 400 can communicate with one another, with external systems, and with FHV display data systems 450 using the system bus 430. The tracking system 400 can communicate with FHV display data systems 450 using any suitable communication means including wireless communication and wired communication.

The tracking system 400 includes the data change tracking module 410 configured to receive and compile display change information from the FHV display data systems 450. The data change tracking module 410 can receive display data 455 and vehicle data 460 from the FHV display data systems 450 for each of the FHVs in communication with the tracking system 400. The display data 455 can include which message was displayed and the times and locations it was displayed. The vehicle data 460 can include vehicle routes travelled and vehicle properties when display data changed (e.g., location, speed, operational state, transmission mode, etc.). The data change tracking module 410 can process this information using the controller 420 to compile a list of transition locations, safe zones, change points, change locations, change times, advertisements displayed, routes that were travelled while particular advertisements were displayed, vehicle properties when changes occurred, and the like. This information can be provided to advertisers or advertisement vendors to calculate fees to charge. For example, fees can be based at least in part on actual display times and actual display locations. This information can be based at least in part on display change times and routes traveled while an advertisement was on the display 104.

The tracking system 400 includes the display analysis module 405 configured to receive data change information from the data change tracking module 410. The display analysis module 405 is configured to perform a statistical analysis on the display change information to compute properties associated with data changes. For example, the display analysis module can use the data change information to calculate an average time from when a display change is requested or warranted until the display is actually changed. This can allow the tracking system 400 to calculate a predicted time between a display-change request and when the display is actually changed, and this can be performed for any number of FHVs. Statistical predictions can be made of a number of FHVs that will display a requested message within a particular time window. For example, the statistical predictions can be used when selling advertising space to advertisers to indicate to the advertiser that within a statistically predicted time frame (e.g., 1 hour), a statistically predicted number of FHVs (e.g., 100) would carry a requested advertisement until a termination of an advertising campaign. The display analysis module 405 can analyze the data change information to determine a frequency of satisfaction of change conditions, e.g., the display analysis module 405 can determine how often change conditions are satisfied for an average FHV.

The tracking system 400 includes the transition feedback module 415 configured to analyze data change information to identify locations where change conditions are met. This information can be used as suggested locations for FHV operators when they are requested to satisfy transition conditions so that a display can automatically change. This information can be presented to the driver using the notification system 110. The transition feedback module 405 can be used by the tracking system 400 to create statistical models of expected change times by comparing vehicle travel patterns and distributions of transition zones (e.g., locations where transition conditions are expected to be met).

The tracking system 400 includes the controller 420 configured to interact with the modules, data storage 425, and external systems. The controller 420 can include one or more physical processors and can be used by any of the other components, such as the display analysis module 405, to process information. The tracking system 400 includes data storage 425. Data storage 425 can include physical memory configured to store digital information and can be coupled to the other components of the tracking system 400, such as the controller 420, the display analysis module 405, the data change tracking module 410, and the transition feedback module 415.

### CONCLUSION

Throughout this disclosure, reference is made to FHVs which can include taxis, limos, shuttles, and the like. The disclosed systems and methods can be used in conjunction with other vehicles as well, including, for example, buses, bikes, cars, trucks, trains, boats, airplanes, and so on. Furthermore, reference is made to advertisers throughout this disclosure to refer to a person or entity paying for and/or providing information to be displayed on a dynamic display on a FHV, and may be any person or entity that pays for and/or provides such information for display, such as media providers, political campaigns, non-profit organizations, clubs, and the like. Reference is also made to advertisements throughout this disclosure to refer to information displayed on a display of a FHV. The information displayed can be any form of information regardless of whether it is an advertisement.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described herein generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure. Further, the headings used herein should not be used to limit the scope of the claims, as they merely illustrate example embodiments.

As used herein, the term “processor” refers broadly to any suitable device, logical block, module, circuit, or combination of elements for executing instructions. For example, the controllers 220, 420 can be any conventional general purpose single- or multi-chip microprocessor such as a Pentium® processor, a MIPS® processor, a Power PC® processor, AMD® processor, ARM® processor, or an ALPHA® processor. In addition, the controllers 220, 420 can be any conventional special purpose microprocessor such as a digital signal processor. The various illustrative logical blocks, modules, and circuits described in connection with the embodiments disclosed herein can be implemented or performed with a general purpose processor, a digital signal processor (DSP), an application specific integrated circuit (ASIC), a field programmable gate array (FPGA), or other programmable logic device, discrete gate or transistor logic, discrete hardware components, or any combination thereof designed to perform the functions described herein. A general purpose processor, such as controllers 220, 420, can be a conventional microprocessor, but the controllers 220, 420 can also be any conventional processor, controller, microcontroller, or state machine. Controllers 220, 420 can also be implemented as a combination of computing devices, e.g., a combination of a DSP and a microprocessor, a plurality of microprocessors, one or more microprocessors in conjunction with a DSP core, or any other such configuration.

Data storage 225, 425 can refer to electronic circuitry that allows information, typically computer or digital data, to be stored and retrieved. Data storage 225, 425 can refer to external devices or systems, for example, disk drives or solid state drives. Data storage 225, 425 can also refer to fast semiconductor storage (chips), for example, Random Access Memory (RAM) or various forms of Read Only Memory (ROM), which are directly connected to the communication bus or one or more processors of the display management system 200. Other types of memory include bubble memory and core memory. Data storage 225, 425 can be physical hardware configured to store information in a non-transitory medium.

Methods and processes described herein may be embodied in, and partially or fully automated via, software code modules executed by one or more general and/or special purpose computers. The word “module” refers to logic embodied in hardware and/or firmware, or to a collection of software instructions, possibly having entry and exit points, written in a programming language, such as, for example, C or C++. A software module may be compiled and linked into an executable program, installed in a dynamically linked library, or may be written in an interpreted programming language such as, for example, BASIC, Perl, or Python. It will be appreciated that software modules may be callable from other modules or from themselves, and/or may be invoked in response to detected events or interrupts. Software instructions may be embedded in firmware, such as an erasable programmable read-only memory (EPROM). It will be further appreciated that hardware modules may comprise connected logic units, such as gates and flip-flops, and/or may be comprised of programmable units, such as programmable gate arrays, application specific integrated circuits, and/or processors. The modules described herein can be implemented as software modules, but also may be represented in hardware and/or firmware. Moreover, although in some embodiments a module may be separately compiled, in other embodiments a module may represent a subset of instructions of a separately compiled program, and may not have an interface available to other logical program units.

In certain embodiments, code modules may be implemented and/or stored in any type of computer-readable medium or other non-transitory computer storage device. In some systems, data (and/or metadata) input to the system, data generated by the system, and/or data used by the system can be stored in any type of computer data repository, such as a relational database and/or flat file system. Any of the systems, methods, and processes described herein may include an interface configured to permit interaction with users, operators, other systems, components, programs, and so forth.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration. Although described herein primarily with respect to digital technology, a processor may also include primarily analog components. For example, any of the signal processing algorithms described herein may be implemented in analog circuitry. A computing environment can include any type of computer system, including, but not limited to, a computer system based on a microprocessor, a mainframe computer, a digital signal processor, a portable computing device, a personal organizer, a device controller, and a computational engine within an appliance, to name a few.

The steps of a method, process, or algorithm described in connection with the embodiments disclosed herein can be embodied directly in physical computer hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of non-transitory computer-readable storage medium, media, or physical computer storage known in the art. An exemplary storage medium can be coupled to the processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment. The terms “comprising,” “including,” “having,” and the like are synonymous and are used inclusively, in an open-ended fashion, and do not exclude additional elements, features, acts, operations, and so forth. Also, the term “or” is used in its inclusive sense (and not in its exclusive sense) so that when used, for example, to connect a list of elements, the term “or” means one, some, or all of the elements in the list.

While the detailed description herein has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments of the inventions described herein can be embodied within a form that does not provide all of the features and benefits set forth herein, as some features can be used or practiced separately from others.

1. A for-hire vehicle display system that automatically changes a display when transition conditions are satisfied, the system comprising:
a for-hire vehicle;
a dynamic display unit attached to the for-hire vehicle, the dynamic display unit comprising an electronic display configured to display information to observers outside of the for-hire vehicle;
a positioning system coupled to the for-hire vehicle, the positioning system configured to provide a location of the for hire vehicle; and
a display management system configured to control the dynamic display unit and receive information from the on-board diagnostic system and the positioning system, the display management system comprising:
physical data storage configured to store a transition condition; and
a physical processor configured to implement computer-readable instructions that configure the physical processor to:
identify a location that satisfies the transition condition;
determine directions to the location that satisfies the transition condition;
display the directions to the location on a notification display; and
determine when the transition condition has been satisfied, the determination being based at least in part on location information received by the display management system from the the positioning system,
wherein the display management system is configured to automatically change the information displayed on the dynamic display unit only when the transition condition is satisfied,
wherein the transition condition is configured to comply with vehicle regulations, traffic laws, or statute.

2. The system of claim 1, further comprising a notification system configured to indicate suggested locations for changing the information displayed on the dynamic display unit.

3. The system of claim 1, wherein the transition condition is satisfied when the for-hire vehicle and surrounding vehicles are stopped.

4. The system of claim 1, wherein the transition condition is satisfied when the for-hire vehicle is located within a designated transition location.

5. The system of claim 4, wherein the designated transition location is defined by statute.

6. The system of claim 4, wherein the designated transition location is off of a public right-of-way.

7. The system of claim 4, wherein the designated transition location is greater than about 25 feet from a public right-of-way.

8. The system of claim 4, wherein the designated transition location is at a taxi stand.

9. The system of claim 1, wherein the transition condition is satisfied when an average speed of neighboring vehicles is less than or equal to 20 mph.

10. The system of claim 1, wherein the transition condition is satisfied when a speed of the for-hire vehicle is less than or equal to 20 mph.

11. The system of claim 1, wherein the transition condition is satisfied when the for-hire vehicle is on a road whose speed limit is less than or equal to 20 mph.

12. The system of claim 1, wherein the display management system is configured to determine information to display on the dynamic display unit based at least partly on a planned navigation route.

13. A method of changing a message displayed on a dynamic electronic display attached to a for-hire vehicle, the method comprising:
receiving vehicle information comprising a speed of the for-hire vehicle and a location of the for-hire vehicle;
receiving message data comprising a list of messages and associated display parameters wherein each message is associated with at least one display parameter;
determining, for at least one message from the list of messages, whether a display condition is satisfied wherein the display condition comprises satisfying one or more of the at least one display parameter associated with the at least one message from the list;
identifying a location that satisfies a transition condition;
determining directions to the location that satisfies the transition condition;
displaying the directions to the location on a notification display;
determining, using at least one computer processor, whether the transition condition is satisfied, based, at least in part, on the location of the vehicle; and
changing the message displayed on the dynamic electronic display if the display condition is satisfied and the transition condition is satisfied.

14. The method of claim 13, further comprising notifying an operator of the for-hire vehicle of a new message being displayed on the dynamic electronic display.

15. The method of claim 13, wherein determining whether the transition condition is satisfied comprises determining if the speed of the for-hire vehicle is less than or equal to a speed threshold.

16. The method of claim 15, wherein the speed threshold is 20 mph.

17. The method of claim 13, wherein determining whether the transition condition is satisfied comprises determining if the location of the for-hire vehicle is within a transition zone.

18. The method of claim 17, wherein the transition zone includes a taxi stand.

19. The method of claim 17, wherein the transition zone includes any location off of a public-right of way.

20. The method of claim 17, wherein the transition zone includes any location that is at least 25 feet from a public right-of-way.
